(19) United States
(12) Patent Application Publication
(10) Pub. No.: US 2026/0081362 A1
(43) Pub. Date: Mar. 19, 2026

(54) Screen Printed Multi-Element Antenna

(71) Applicant: ISRAEL AEROSPACE INDUSTRIES LTD., Lod (IL)

(72) Inventors: Gregory LUKOVSKY, Givat Shmuel (IL); Itay LASMAN, Rehovot (IL); Zion Elad TACHAN, Kfar Sirkin (IL); Nir AMIT, Tel Aviv (IL); Dana MEZAN, Rishon Letzion (IL); Reuven BAUER, Rehovot (IL); Eli Aviram GRUNBERG, Petach Tiqwa (IL); Oren MAHLEB, Holon (IL)

(21) Appl. No.: 19/328,210

(22) Filed: Sep. 14, 2025

(30) Foreign Application Priority Data
Sep. 15, 2024 (IL) 315668

(51) Int. Cl. H01Q 21/00; D06P 5/15; D06P 5/30; H01Q 1/08; H01Q 1/48; H01Q 21/24

(52) U.S. Cl. CPC H01Q 21/0087; D06P 5/15; D06P 5/30; H01Q 1/085; H01Q 1/48; H01Q 21/24

(57) ABSTRACT

A phased array antenna comprising a plurality of antenna modules, each antenna module comprising a radiating element made of an electrically conductive material printed on a fabric substrate by a screen-printing process and/or an inkjet printing process; and, a signal input port comprising at least one probe electrically coupled to said radiating element, said probe being configured to be coupled to a corresponding transceiver module so that an amplitude and phase of each of said radiating elements can be independently controlled. Further, a method for manufacturing the phased array antenna, comprising: printing an electrically conductive material on a fabric substrate by a screen-printing process and/or an inkjet printing process, so as to form said radiating element for each of the antenna modules; and for each of the antenna modules, electrically coupling said radiating element to said signal input port, thereby assembling the plurality of antenna modules.

### CROSS REFERENCE TO RELATED APPLICATIONS

This application claims the benefit of priority from Israeli patent application No. 315668 which is incorporated herein by reference in its entirety.

### TECHNOLOGICAL FIELD

The present disclosure is related to the field of printed electronic devices, more particularly, to flexible antenna devices.

### BACKGROUND

Flexible electronics is an interdisciplinary field dealing with electronic circuits (and applications of them) configured to be mechanically non-rigid. That is, configured to conform to applied forces, e.g., stretching, bending, and/or shearing. Prominent applications of flexible electronics include wearable devices, smart toys, and foldable smartphones. The field of flexible electronics includes flexible antennas. Such antenna may be used for transmission and receiving of data, and for transmission of power (e.g., wireless charging). Examples of flexible antennas are described in U.S. Pat. Nos. 9,548,543 and 11,616,293.

### GENERAL DESCRIPTION

There is still a need in the art for a cheap, quickly manufactured, large, and mechanically flexible phased-array antennas. Further, there is a need for such phased-array antennas that can provide a wide range of capabilities.

In a first aspect of the presently disclosed subject matter, there is provided a phased array antenna. The phased array antenna includes a plurality of antenna modules. Each antenna module includes a radiating element, made of an electrically conductive material, and printed on a fabric substrate. The printing of the radiating element is by any one of: a screen-printing process, and an inkjet printing process. Each antenna module includes a signal input port, comprising at least one probe. The at least one probe is electrically coupled to the radiating element. The at least one probe is configured to be coupled to a corresponding transceiver module, so that an amplitude and phase of each of said radiating elements can be independently controlled.

In addition to the above features, a phased array antenna according to this aspect of the presently disclosed subject matter, can optionally comprise one or more of features (i) to (xix) below, in any technically possible combination or permutation:
i. the radiating element includes a plurality of patches.
ii. the signal input port is electrically coupled to the radiating element by any one of a soldering, and a conductive adhesive.
iii. the at least one probe is aligned perpendicularly to a surface of the fabric substrate.
iv. the at least one probe includes any one of a pin, a rivet, and a conductive via.
v. the radiating elements are printed on a first side of the fabric substrate. Further, a ground plane disposed on a second side of the fabric substrate.
vi. the ground plane is printed on the fabric substrate by any one of: a screen-printing process, and an inkjet printing process.
vii. the at least one probe is electrically coupled to the at least one radiating element by a conductive adhesive, and mechanically attached to the ground plane by a non-conductive adhesive.
viii. the signal input port includes a coaxial radio frequency connector.
ix. the coaxial radio frequency connector is a SMA connector. A lead of the SMA connector is electrically coupled to a corresponding radiating element by a conductive adhesive. A flange of the SMA connector is electrically coupled to the ground plane by a conductive adhesive.
x. some antenna modules are configured for radiating in a first polarization, and some radiating antenna modules are configured for radiating in a second polarization.
xi. the first polarization and the second polarization are orthogonal polarizations.
xii. including dual polarization antenna modules.
xiii. including at least one secondary layer.
xiv. including an insulating layer being disposed on the radiating elements. The at least one secondary layer is disposed on the insulating layer.
xv. including an insulating layer being disposed on the ground plane. The at least one secondary layer is disposed on the insulating layer.
xvi. the at least one secondary layer is printed by any one of: a screen-printing process, and an inkjet printing process.
xvii. mechanically attached to a curved template surface.
xviii. including a protective cover.
xix. the protective cover includes a resin matrix.

In a second aspect of the presently disclosed subject matter, there is provided a phased array antenna system. The phased array antenna includes a plurality of transceiver modules, and a phased array antenna according to the first aspect of the presently disclosed subject matter. Each transceiver module is electrically coupled to the at least one probe, so as to provide electromagnetic signals to the plurality of antenna modules.

According to some embodiments, the plurality of transceiver modules are configured for phase correcting the signals.

In a third aspect of the presently disclosed subject matter, there is provided a method for manufacturing a phased array antenna. The phased array antenna includes a plurality of antenna modules. Each antenna module includes a radiating element, and a signal input port. The signal input port includes at least one probe configured to be coupled to a corresponding transceiver module, so that an amplitude and phase of each of the radiating elements can be independently controlled.

The method includes printing an electrically conductive material on a fabric substrate, by any one of: a screen-printing process, and an inkjet printing process. The printing is so as to form the radiating element for each of the antenna modules. The method includes, for each of the antenna modules, electrically coupling the radiating element to the signal input port, thereby assembling the plurality of antenna modules.

In addition to the above features, a method for manufacturing a phased array antenna, according to this aspect of the presently disclosed subject matter, can optionally comprise one or more of features and steps (i) to (xviii) below, in any technically possible combination or permutation:
i. the radiating element includes a plurality of patches.
ii. electrically coupling the radiating element to the signal input port includes any one of soldering the at least one probe to the radiating element, and gluing the at least one probe to the radiating element by a conductive adhesive.
iii. the at least one probe is aligned perpendicularly to a surface of the fabric substrate.
iv. the at least one probe includes any one of a pin, a rivet, and a conductive via.
v. the radiating elements are printed on a first side of the fabric substrate. Further, the method includes printing a ground plane on a second side of the fabric substrate.
vi. the ground plane is printed by any one of: a screen-printing process, and an inkjet printing process.
vii. electrically coupling the radiating element to the signal input port includes gluing the at least one probe to the radiating element by a conductive adhesive. Further, the method includes gluing the at least one probe to the ground plane by a non-conductive adhesive.
viii. the signal input port includes a coaxial radiofrequency connector.
ix. the coaxial radiofrequency connector is a SMA connector. The method further includes gluing a lead of the SMA connector to the radiating element by a conductive adhesive, and gluing a flange of the SMA connector to the ground plane by a conductive adhesive.
x. some antenna modules are configured for radiating in a first polarization, and some antenna modules are configured for radiating in a second polarization.
xi. the first polarization and the second polarization are orthogonal polarizations.
xii. some antenna modules are dual polarization antenna modules.
xiii. disposing an insulating layer on the radiating elements, and disposing electrically conductive material on the insulating layer. Thereby, forming at least one secondary layer.
xiv. disposing an insulating layer on the ground plane, and disposing electrically conductive material on the insulating layer. Thereby, forming at least one secondary layer.
xv. the at least one secondary layer is printed by any one of: a screen-printing process, and an inkjet printing process.
xvi. mechanically attaching the phased array antenna to a curved template surface.
xvii. disposing a protective cover.
xviii. embedding in a resin matrix.

In the present disclosure, the following terms and their derivatives may be understood according to the below explanations:

The term “signal input port” may refer to a signal feed port, where a radiating element may be provided with an electromagnetic signal.

The term “transceiver module”, depending on context, may refer to a transmitter module (Tx), a receiver module (Rx) and/or a transmitter/receiver module (T/R).

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B schematically illustrate phased array antennas according to embodiments of the present disclosure.

FIGS. 2A-2C schematically illustrate a general structure of phased array antennas according to embodiments of the present disclosure.

FIGS. 3A-3C schematically illustrate exemplary radiating elements, according to embodiments of the present disclosure.

FIGS. 4A-4C illustrate phased array antennas according to embodiments of the present disclosure.

FIG. 5 schematically illustrates phased array antenna systems according to embodiments of the present disclosure.

FIG. 6 shows a flowchart schematically illustrating methods for manufacturing a phased array antenna, according to embodiments of the present disclosure.

### DETAILED DESCRIPTION OF EMBODIMENTS

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrases “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example. The term “each” may not be exclusively understood as referring to each and every, and when technically relevant may also refer to “at least some”.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

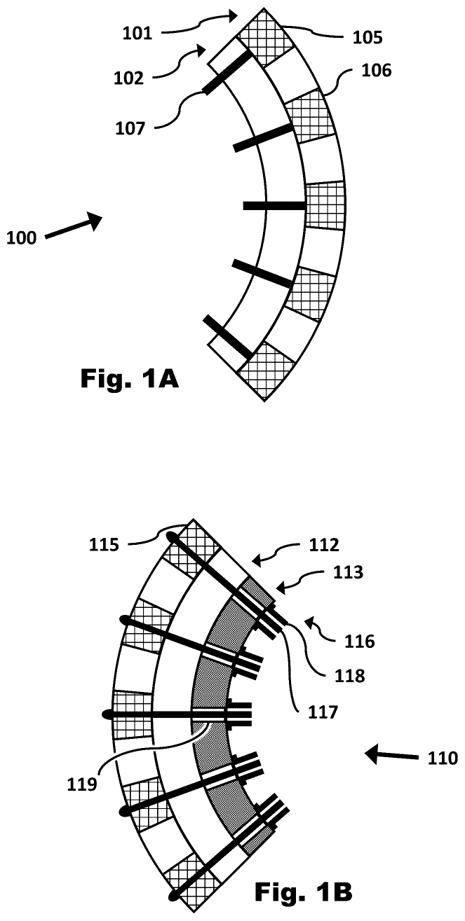

Referring to FIG. 1A, phased array antenna 100, according to embodiments of the present disclosure, is schematically illustrated. The phased array antenna 100 may include a plurality of antenna modules. Each antenna module may include a radiating element, such as radiating elements 105 106. The radiating elements may be configured to emit electromagnetic radiation. The radiating element may be made of an electrically conductive material. The electrically conductive material may be printed on a fabric substrate 102 by a screen-printing process. In other words, the radiating element may be a patch of an electrically conductive ink, that may be printed and cured on a fabric substrate 102 by a screen-printing process. In some embodiments, the radiating element may include a plurality of patches.

Examples of materials that may be included in fibers of the fabric substrate 102 include, but not limited to: natural fibers (e.g., cotton, wool, cellulose), silica (e.g., fiberglass), aromatic polyamides (e.g., Kevlar), silicones (e.g., PDMS), polyimide, polyesters, polyurethanes, and polyethylene (e.g., PET, PEN, HDPE).

In some embodiments, the fabric substrate 102 may include a plurality of layers. In other words, the fabric substrate 102 may be non-monolithic. In yet other words, the fabric substrate 102 may be composite. For example, the fabric substrate 102 may include two or more layers of fabric bonded by an adhesive or sewn together. The two fabric layers may be of similar material composition or may be of a dissimilar material composition. In another example, the fabric substrate 102 may include a coated fabric.

A composite fabric substrate may be required in order to fulfil mechanical and/or electrical specifications. For example, mechanical strength and dielectric properties.

Examples of materials that may be included in the electrically conductive material include, but not limited to: metal nanoparticles (e.g., copper, silver, gold), conductive polymers (e.g., polyaniline, polypyrrole, PEDOT+PSS), graphene, carbon nanotubes, and low melting point alloys (e.g., Galinstan having a melting point above room temperature).

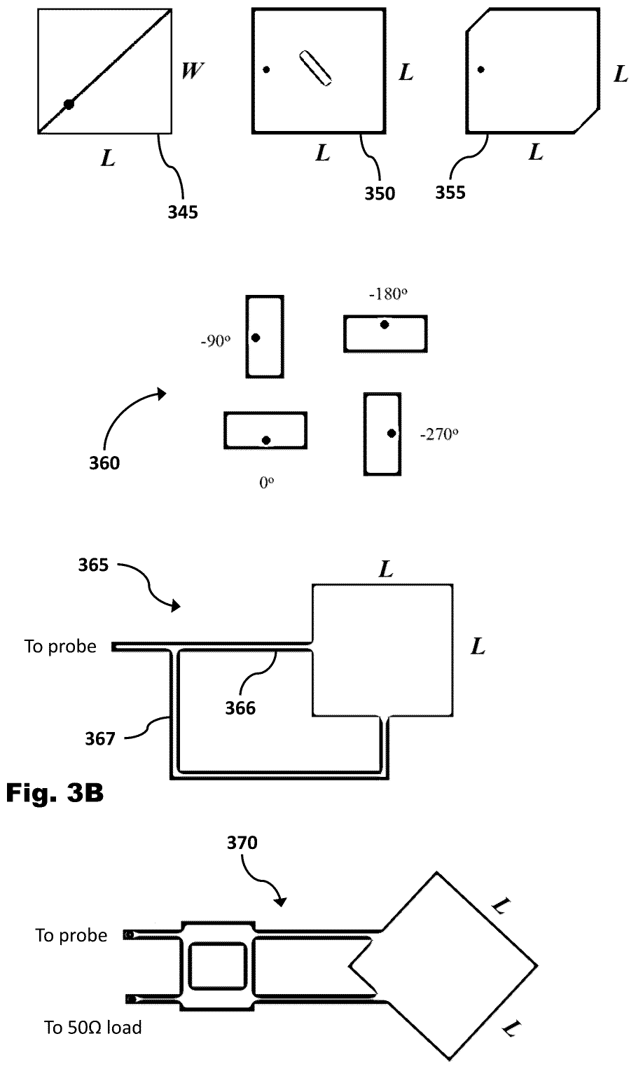

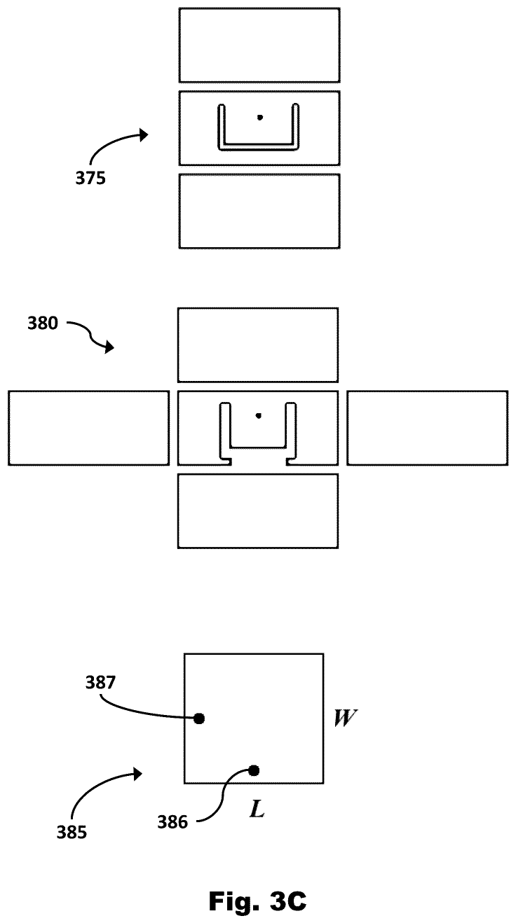

Examples of radiating elements are further described hereinbelow in relation to FIGS. 3A-3C.

Each antenna module may include a signal input port. In some embodiments, at least some antenna modules may include more than one signal input port. The signal input port may include at least one probe. That is, an electrical lead that may be not printed on the fabric substrate 102. Examples of probes include a pin (such as pin 107), a rivet, and/or a conductive via. In some embodiments, the at least one probe may include a conductive fiber (e.g., an e-thread). In some embodiments, the at least one probe may be aligned perpendicularly to a surface of the fabric substrate 102.

The at least one probe may be electrically coupled to the radiating element. In other words, the at least one probe may be configured to provide (transfer) electromagnetic signals to the radiating elements. Examples of electrical couplings include galvanic coupling (i.e., an electrically conductive path between the at least one probe and the radiating element), and proximity coupling, such as capacitive coupling, and/or inductive coupling.

In some embodiments, where the electrical coupling may include galvanic coupling, an electrical coupling of the at least one probe to the radiating element may include soldering and/or a conductive adhesive. The soldering and/or the conductive adhesive may also provide mechanical fixation of probes to the radiating element. In some embodiments, the at least one probe may be mechanically attached to the fabric substrate 102 by an adhesive.

In some embodiments, where the electrical coupling may include proximity coupling, the input port may include a patch of conductive material galvanically coupled to the at least one probe. For example, a microstrip line.

The at least one probe may be configured to be coupled to a corresponding transceiver module, so that an amplitude and phase of each of the radiating elements can be independently controlled. In other words, the amplitude and phase of a signal provided to any radiating element, may be controlled independently of the amplitude and phase of a signal provided to any other radiating element.

It is noted that due to electromagnetic reciprocity, the phased array antenna 100 can receive signals, in conjunction to or instead of transmitting (radiating) signals. The antenna modules may function as radiation receiving antennas. Signals received at each transceiver module may be independently processed (e.g., an amplitude and/or phase may be independently manipulated).

In some embodiments, each antenna module may consist of the radiating element and the at least one input port. In some embodiments, at least some antenna modules may include auxiliary elements. The auxiliary elements may be patches and/or strips made of an electrically conductive material and/or a dielectric material. The auxiliary elements may be configured to modify a radiation pattern of the radiating element, so as to obtain a desired radiation pattern. In other words, the auxiliary elements may be passive (not-active) electrical elements. The radiation pattern may include a spatial distribution of power radiated by the radiating element, and/or a frequency response of the radiating element to signals provided to the radiating element through the at least one input port. The auxiliary elements may be printed on a fabric substrate 102 by a screen-printing process.

The plurality of radiating elements and auxiliary elements may be referred to as “radiating layer” 101.

In some embodiments, the phased array antenna 100 may be configured for radiating in more than one polarization. In other words, the phased array antenna 100 may be configured for emitting electromagnetic radiation comprising at least two polarizations. For example, linear polarizations along distinct axes, and/or elliptical polarizations having distinct Jones vectors. In some embodiments, the at least two polarizations may include orthogonal polarizations. e.g. horizontal and vertical polarizations, and/or left-handed and right-handed circular polarizations. For each polarization, the phased array antenna 110 may include at least some antenna modules that may be configured for radiating in that polarization.

In some embodiments, the phased array antenna 100 may be configured for emitting electromagnetic radiation comprising two polarizations. The phased array antenna 100 may include at least some antenna modules that may be configured for radiating in a first polarization (e.g., an elliptical polarization having a first Jones vector). Further, the phased array antenna 100 may include at least some antenna modules that may be configured for emitting electromagnetic radiation having a second polarization (e.g., an elliptical polarization having a second Jones vector). In some embodiments, the first polarization and the second polarization may be orthogonal polarizations, e.g. horizontal and vertical polarizations, or left-handed and right-handed circular polarizations.

In some embodiments, the phased array antenna 100 may include dual polarization antenna modules. That is, antenna modules including radiating elements and signal input ports configured for radiating in more than one polarization. Therefore, the same antenna modules may be configured for radiating in more than one polarization. Dual polarization radiating elements are further described hereinbelow in relation to FIG. 3C.

A ground plane may be external to the antenna. For example, the ground plane may be a part of a platform utilizing the phased array antenna 100.

The phased array antenna 100 may be mechanically flexible. Thus, the phased array antenna 100 may be fitted to a variety of applications having different shape constraints. For example, for avionics applications, the phased array antenna 100 may be fitted to a shape of an aircraft, so as to avoid increasing a drag coefficient of the aircraft. In some embodiments, the phased array antenna 100 may be mechanically attached to a curved template surface. In other words, the phased array antenna 100 may be mechanically attached to a curved surface of a platform, or more generally, a curved surface that may define a shape of the phased array antenna 100. For example, a nose cone of an aircraft or a shaft of a missile. The mechanical coupling may include fasteners and/or an adhesive. The attachment may be so the phased array antenna 100 may conform to the shape of the template surface. In other words, the shape of the template surface may be a template to the shape of the phased array antenna 100, when the phased array antenna 100 may be attached to the template surface. In yet other words, the array antenna 100 may assume the shape of the template surface. For example, the template surface may be a shaft of the missile. The phased array antenna 100 may be bent so as when attached to the shaft, the array antenna 100 may assume the curvature of the shaft.

Generally, the phased array antenna 100 may be attached to a non-planar platform. For example, the phased array antenna 100 may be installed on (attached to) a plurality of non-colinear poles, so as to implement a multi-directional antenna. The phased array antenna 100 may be bent by at least one pole.

In some embodiments, the attachment of the phased array antenna 100 to a platform may be reversible. In other words, the phased array antenna 100 may be detachable from the platform.

As indicated hereinabove, the electrically conductive material may be printed on a fabric substrate 102 by a screen-printing process. In some embodiments, an inkjet printing process (also known as digital printing) may be used in conjunction to the screen-printing process or instead of the screen-printing process. In other words, an inkjet printing process may replace the screen-printing process, partially or completely.

Referring to FIG. 1B, phased array antenna 110, according to embodiments of the present disclosure, is schematically illustrated. The phased array antenna 110 may be a variant of the phased array antenna 100.

The phased array antenna 110 may include a plurality of antenna modules. Each antenna module may include a radiating element, such as radiating element 115. The radiating elements may be configured to emit electromagnetic radiation. The radiating element may be made of an electrically conductive material. The electrically conductive material may be printed on a fabric substrate 112 by a screen-printing process.

The phased array antenna 110 may include a ground plane 113. The ground plane 113 may be printed on the fabric substrate 112 on a side opposite of the radiating layer 111. In other words, the plurality of radiating elements may be printed on a first side of the fabric substrate 112, and the ground plane 113 may be printed on a second side of said fabric substrate 112. In some embodiments, the ground plane 113 may be printed by a screen-printing process.

Each antenna module may include a signal input port. The signal input port may include at least one probe. That is, an electrical lead that may be not printed on the fabric substrate 112. The signal input port may include a coaxial radio frequency connector, such as connector 116. An inner conductor (e.g., the center pin) 117 may be electrically coupled to a (corresponding) radiating element, and an outer conductor (e.g., the electromagnetic braid shield) 118 may be galvanically coupled to the ground plane 113 (e.g., by soldering or by a conductive adhesive). In some embodiments, the inner conductor 117 may be galvanically coupled to the radiating element. Examples of radio frequency connectors include, but not limited to: N-type, BNC, TNC, SMA, and F-type. In some embodiments, the coaxial radio frequency connector may be a SMA connector. A lead (core conductor) of the SMA connector may be electrically coupled to a radiating element by a conductive adhesive. A flange (outer conductor) of said SMA connector may be electrically coupled to the ground plane 113 by a conductive adhesive.

The at least one probe may be electrically coupled to the radiating element. In other words, the at least one probe may be configured to transfer electromagnetic signals to the radiating elements.

The at least one probe may be configured to be coupled to a corresponding transceiver module, so that an amplitude and phase of each of the radiating elements can be independently controlled. In other words, the amplitude and phase of a signal provided to any radiating element, may be controlled independently of the amplitude and phase of a signal provided to any other radiating element.

The probes may be galvanically uncoupled from the ground plane 113. In other words, the probes and the ground plane 113 may be electrically insulated from each other. For example, insulators (such as an insulator 119) may be disposed between the probes and the ground plane 113, and/or holes may be included in the ground plane 113, positioned where probes may pass. In some embodiments, the probes may be electrically coupled to the radiating elements by a conductive adhesive, and may further be mechanically attached to the ground plane 113 by a non-conductive adhesive (so as to prevent short-circuiting the radiating element to the ground plane 113).

It is noted that in some embodiments, the phased array antenna 110 may further include features described hereinabove in relation to phased array antenna 100, for example, configuration for radiating in more than one polarization, and auxiliary elements. The description of such features is not repeated.

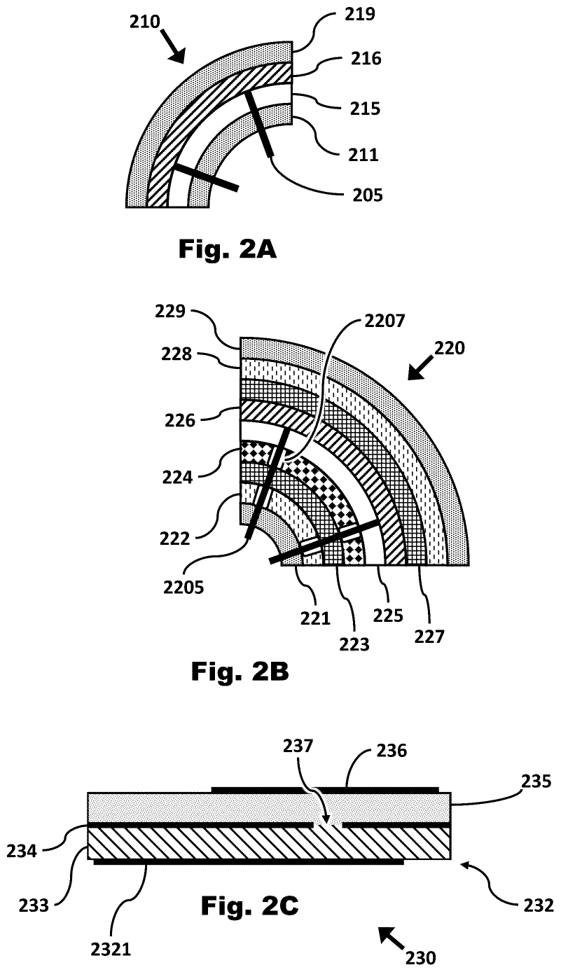

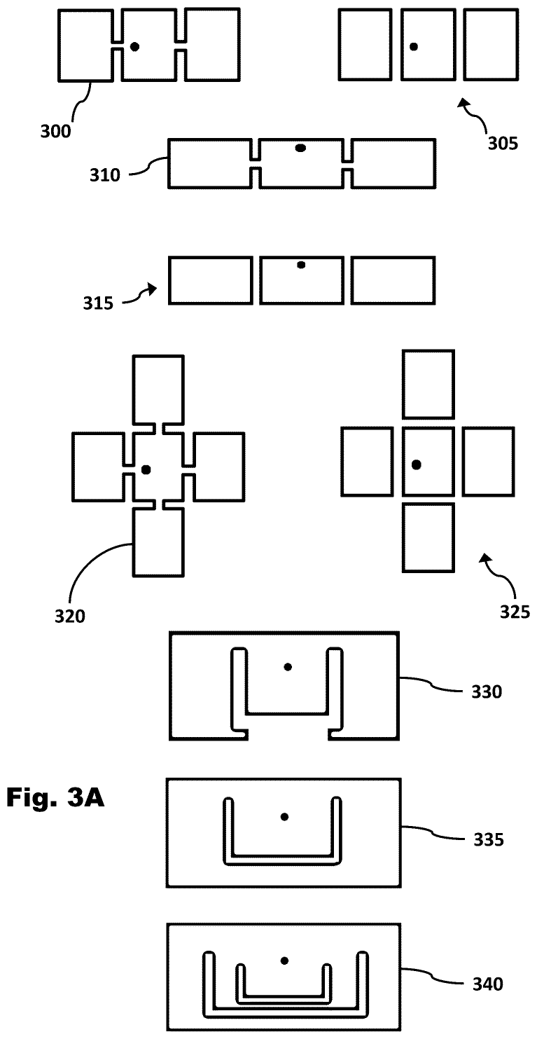

Referring to FIG. 2A, a general structure, of phased array antenna 210 according to embodiments of the present disclosure, is illustrated. The phased array antenna 210 may be a variant of the phased array antenna 100.

The phased array antenna 210 may include a plurality of antenna modules (not shown), each including a radiating element. The radiating elements (of the plurality of antenna modules) may be printed on a fabric substrate 215 by a screen-printing process. The antenna modules may each include an input port electrically coupled to the radiating element. The signal input port may include at least one probe, such as probe 205. The radiating elements, and optionally auxiliary elements (as described hereinabove), may form a radiating layer 216.

The phased array antenna 210 may include protective cover. The protective cover may include a first cover layer 219 mechanically attached to the radiating layer 216. The protective cover may include a second cover layer 211 mechanically attached to the fabric substrate 215. The protective cover may provide protection of the antenna 210 from damage, e.g., impact of foreign objects. In other words, the protective cover may be a radome attached to the phased array antenna 210. The protective cover may provide structural integrity for the phased array antenna 210. In some embodiments, the protective cover may include a resin matrix. In other words, the protective cover may include a cured resin, such as an epoxy resin. In some embodiments, the protective cover may be configured to be detachable from the phased array antenna 210. In some embodiments, the protective cover may be configured to be re-attachable to the phased array antenna 210.

In some embodiments, where a protective cover may be incorporated into the phased array antenna 210, the protective cover may be a template surface. For example, in some embodiments, where the protective cover may include a resin matrix, the cured resin may be shaped (e.g., machined) to a desired shaped, or the phased array antenna 210 may be immersed in a bath of liquid resin having the desired shape, thereby the resin may cure into the desired shape.

It is noted that in some embodiments, the phased array antenna 210 may further include features described hereinabove in relation to phased array antenna 100 110, for example, a ground plane, and input ports including RF connectors. The description of such features is not repeated.

Referring to FIG. 2B, a general structure, of phased array antenna 220 according to embodiments of the present disclosure, is illustrated. The phased array antenna 220 may be a variant of the phased array antennas 110 210.

The phased array antenna 220 may include a plurality of antenna modules (not shown), each including a radiating element. The radiating elements (of the plurality of antenna modules) may be printed on a fabric substrate 225 by a screen-printing process. The antenna modules may each include an input port electrically coupled to the radiating element. The signal input port may include at least one probe, such as probe 2205. The radiating elements, and optionally auxiliary elements (as described hereinabove), may form a radiating layer 226. The phased array antenna 220 may include a ground plane 224. The phased array antenna 220 may include protective cover. The protective cover may include a first cover layer 229 and/or a second cover layer 221.

The phased array antenna 220 may include at least one secondary layer. For example, a first secondary layer 228 and a second secondary layer 222. The at least one secondary layer may include printed electrical elements. For example, patches and/or strips made of an electrically conductive material and/or a dielectric material. The plurality of electrical elements included in the first secondary layer 228 and second secondary layer 222 may be configured, for example, to modify a radiation pattern of the radiating elements, and/or to modify coupling properties of input ports to the radiating elements.

The phased array antenna 220 may include a first insulating layer 227. The first insulating layer 227 may be disposed (i.e., positioned) on the radiating layer 226 (and therefore, on the radiating elements). The first secondary layer 228 may be disposed on the first insulating layer 227. The first secondary layer may be described as disposed on a first side of the fabric substrate.

The phased array antenna 220 may include a second insulating layer 223. The second insulating layer 227 may be disposed on the ground plane 224. The second secondary layer 222 may be disposed on the second insulating layer 223. The second secondary layer may be described as disposed on a second side of the fabric substrate.

In some embodiments, the first insulating layer 227 and/or the second insulating layer 223, may be include a fabric.

In some embodiments, the electrical elements included in the at least one secondary layer may be printed by a screen-printing process.

Generally, the number of secondary layers may be variable. That is, more than one secondary layer can be disposed on the first side of the fabric substrate 225, and more than one secondary layer can be disposed on the second side of the fabric substrate 225. An insulating layer may be disposed between adjacent secondary layers disposed on the same side of the fabric substrate 255.

In other words, the first secondary layer 228 and the first insulating layer 227 may be repeated, and/or the second secondary layer 222 and the second insulating layer 223 may be repeated. Therefore, the phased array antenna 220 may include additional layers. Different repetitions of any of the first secondary layer 228, the first insulating layer 227, the second secondary layer 222 and the second insulating layer 223 can include different material composition and/or different structure.

In some embodiments, the at least one probe may be galvanically uncoupled from the at least one secondary layer. In other words, electrical elements included the at least one secondary layer may consist of passive elements. For example, insulators (such as an insulator 2207) may be disposed around the at least one probe. In some embodiments, some probes may be galvanically uncoupled from the at least one secondary layer, where some probes may be galvanically coupled to the at least one secondary layer. In other words, electrical elements included the at least one secondary layer may include active elements.

An exemplary configuration that includes a secondary layer is the aperture coupled patches (ACP), schematically illustrated in FIG. 2C. The phased array antenna 230 may include a second secondary layer 232 may include a plurality of microstrips 2321 being included in the input ports (and galvanically coupled to the probes, probes not shown). The ground plane 234 may include a plurality of apertures 237 corresponding the plurality of microstrips 2321. The plurality of apertures 237 may provide a proximity coupling between the plurality of microstrips 2321 and corresponding radiating elements 236. The second secondary 232 layer may be disposed on an insulating layer 233. The insulating layer 233 may be disposed on the ground plane 234. The ground plane 234 and plurality of radiating elements 236 may be disposed on a fabric substrate 235. For brevity, any other feature, that may be included in phased array antenna 230, is not illustrated.

It is noted that in some embodiments, the phased array antenna 220 230 may further include features described hereinabove in relation to phased array antenna 100 110 210, for example, radio frequency connectors. The description of such features is not repeated.

Referring to FIGS. 3A-3C, exemplary radiating elements, according to embodiments of the present disclosure, are schematically illustrated. A position where a probe may be galvanically coupled to a radiating element is illustrated by a circle.

As indicated hereinabove, in some embodiments, the radiating element may include a plurality of patches. Examples include, but not limited to: Radiating Edges Gap Coupled Microstrip Antenna 305 (REGCOMA), Non-Radiating Edges Gap Coupled Microstrip Antenna 315 (NEGCOMA), and Four Edges Gap Coupled Microstrip Antenna 325 (FEGCOMA).

In some embodiments, the patches (the radiating element) may be galvanically connected by a printed conductor. Examples include, but not limited to: Radiating Edges Direct Coupled Microstrip Antenna 300 (REDCOMA), Non-Radiating Edges Direct Coupled Microstrip Antenna 310 (NEDCOMA), and Four Edges Direct Coupled Microstrip Antenna 320 (FEDCOMA).

Generally, the shape of a radiating element may not be limited. In some embodiments, the shape of a radiating element may be rectangular, square, oval, and/or circular. In some embodiments, the shape of a radiating element may be more complex. Examples include a shape of an E-Patch 330, a U-slot 335 and a double U-slot 340.

As indicated hereinabove, in some embodiments, antenna modules may be configured for radiating circularly polarized radiation. The configuration for radiating circularly polarized radiation may be achieved by a configuration of the radiating element, may be achieved by a configuration of the coupling of the at least one input port to the radiating element, or may be achieved by a configuration of the signal provided by the transceiver module. Examples include, but not limited to: a rectangle-shaped radiating element 345 where the probe may be galvanically coupled to the radiating element at a position along a diagonal of the rectangle; a square radiating element 350 with a diagonal slot; a radiating element 355 having a shape of a square with two opposing corners cut; a plurality of radiating elements 360 provided with quarter-cycle phase shifted signals; dual feeding the radiating element 365 via two micro-strips of different length (micro-strip 367 acts as a delay-line relative to microstrip 366 thereby providing a phase-delay); and a branchline coupler 370.

It is noted that different examples can be combined. For example, a radiating element 375 having a REGCOMA configuration with patches having U-slots (i.e., example 305 combined with example 335), or a radiating element 380 having a FEDCOMA configuration with E-Patches (i.e., example 320 combined with example 330).

As indicated hereinabove, in some embodiments, an antenna module may be configured for radiating in more than one polarization. The antenna module may include at least two signal input ports, each including at least one probe. A coupling of each signal input port to the radiating element may be configured so signals provided to the radiating element by each probe, may be radiated with a corresponding polarization. Signals may simultaneously be provided by the at least two signal input ports, so as to radiate signals in any other polarization. For example, linear polarizations may be combined so as to radiate signals in a circular polarization.

For example, the plurality of radiating elements 360 may each be provided with signals having different amplitudes and phase shifts. The plurality of radiating elements 360 may radiate in an elliptical polarization having a Jones vector according to the amplitudes and phase shifts.

In a different example, a rectangular radiating element 385 may be galvanically coupled to a probe 386 at a position corresponding to a middle of a first edge of the rectangle. Radiating element 385 maybe galvanically coupled to a probe 387 at a position corresponding to a middle of a second edge of the rectangle. The first edge and the second edge may be perpendicular edges. Signals provided to the radiating element 385 via probes 386 387 may be radiated with elliptical polarization having a Jones vector according to relative amplitudes and phase shifts of the signals.

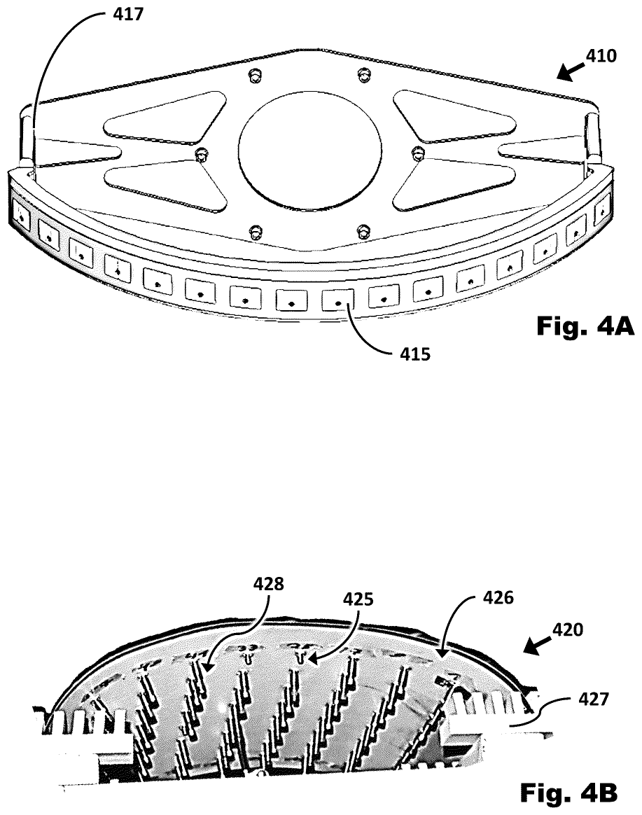

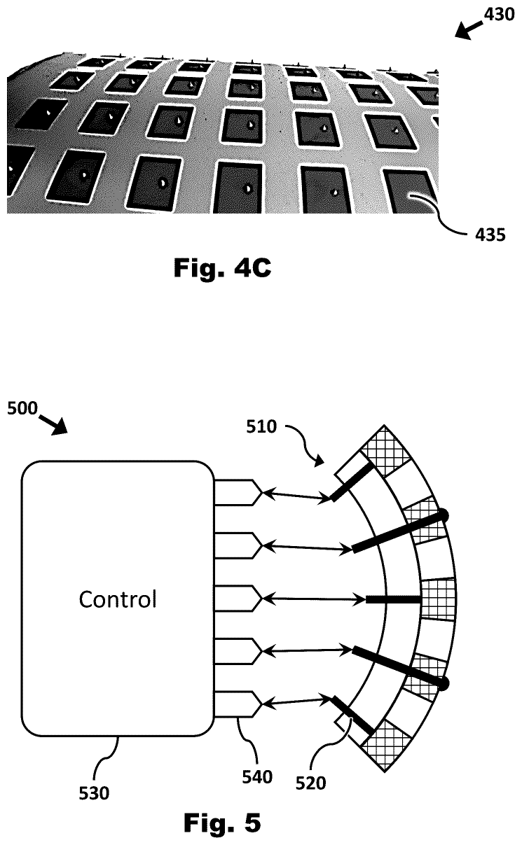

Referring to FIGS. 4A-4C, phased array antennas according to embodiments of the present disclosure are illustrated.

FIG. 4A illustrates a phased array antenna 410 that includes a plurality of antenna modules. Each antenna module includes a radiating element, such as radiating element 415, printed on a fabric substrate by a screen-printing process. Each antenna module includes a signal input port that includes a single probe galvanically coupled to the radiating element. The position of the galvanic coupling is illustrated by a circle. The plurality of antenna modules are arranged as a linear array. The phased array antenna 410 is mechanically attached to a curved surface of a mounting jig 417.

FIG. 4B illustrates a backside of a phased array antenna 420 that includes a plurality of antenna modules. Each antenna module includes a radiating element (not shown) printed on a fabric substrate by a screen-printing process. Each antenna module includes a signal input port that includes a single SMA radio frequency connector 425. A lead of the SMA connector 425 is galvanically coupled to a radiating element. A flange of the SMA connector is galvanically coupled to a ground plane 426. The plurality of antenna modules are arranged as a square grid. The phased array antenna 410 is installed on a test platform 427. Some of the SMA radio frequency connectors are connected to adapters 428 to interface the phased array antenna 420 to test equipment. The phased array antenna 420 is bent to a shape of about a cylindrical sector.

FIG. 4C illustrates a front-side of a phased array antenna 430 that includes a plurality of antenna modules. Each antenna module includes a radiating element printed on a fabric substrate by a screen-printing process, such as radiating element 435. Each antenna module includes a signal input port that includes a single probe (position of galvanic coupling of a radiating element to a probe is illustrated by a point). The plurality of antenna modules are arranged as a square grid. The phased array antenna 430 is bent to a shape of about a cylindrical sector.

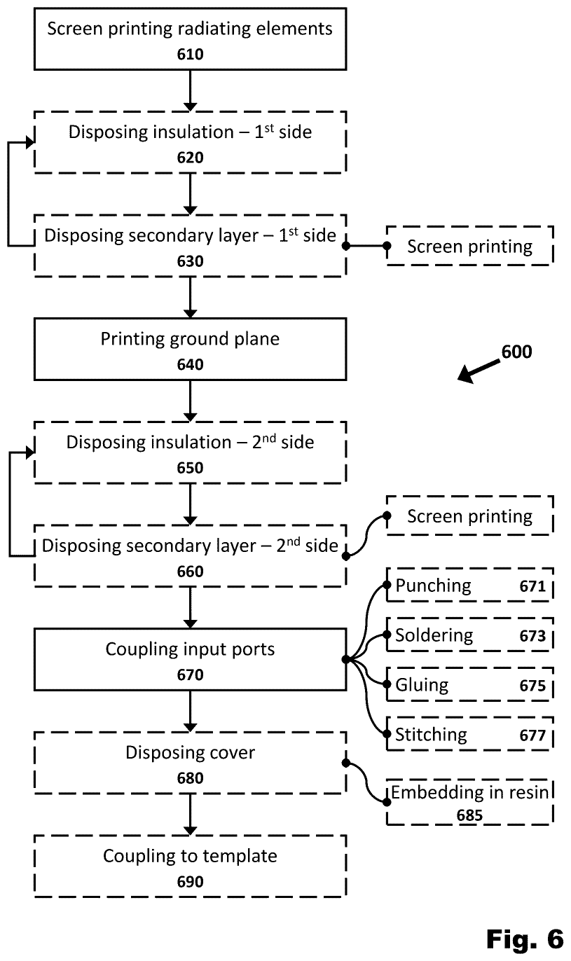

Referring to FIG. 5, phased array antenna systems, according to embodiments of the present disclosure, are schematically illustrated.

Phased array antenna system 500 may include a plurality of transceiver modules, such as transceiver module 540. The phased array antenna system 500 may include a phased array antenna 510. The phased array antenna 510 may be according to any embodiment described hereinabove. Each transceiver module may be electrically coupled to the at least one probe 520, so as to provide electromagnetic signals to the plurality of antenna modules. The phased array antenna system 500 may include a control module 530 that may control the function of the transceiver modules.

In some embodiments, the plurality of transceiver modules may be configured for phase correcting the signals. That is, the plurality of transceiver modules may be configured to provide signals having amplitude and phase that may depend on the exact shape of the phased array antenna 510.

For example, the phased array antenna 510 may be bent to a shape of a cylindrical sector. A transceiver module corresponding an antenna module positioned at an edge of the phased array antenna 510, may provide a signal having a higher amplitude and less phase delay than a transceiver module corresponding an antenna module positioned at a center of the phased array antenna 510. In some embodiments, the transceiver modules may perform phase correcting according to commands provided by the control module 530.

Phase correcting the signals may provide an advantage that the same configuration of antenna may be used for different applications, providing interchangeability of hardware between different applications. Further, mass manufacture of the phased array antenna 510 may be easier (by reducing configurations required to be manufactured), reducing costs and expediting the manufacture process.

In some embodiments, where the phased array antenna system 500 may be configured to perform shape-calibration. The plurality of transceiver modules may be configured to provide low-power signals to the plurality of antenna modules, according to commands of the control module 530. Due to electrical coupling between the antenna modules, the at least one transceiver module may measure signals. The control module 530 may be configured to receive and process the measured signals so as to compute a desired phase correction.

Referring to FIG. 6, a flowchart schematically illustrating a method 600 for manufacturing a phased array antenna, according to embodiments of the present disclosure, is shown.

The phased array antenna may include a plurality of antenna modules. Each antenna module may include a radiating element and a signal input port. The signal input port may include at least one probe configured to be coupled to a corresponding transceiver module, so that an amplitude and phase of each of said radiating elements can be independently controlled

The method 600 may include a step 620 of printing an electrically conductive material on a fabric substrate by a screen-printing process, so as to form the radiating elements for each of the antenna modules. In other words, the method 600 may include a step 620 of screen-printing a plurality of radiating elements.

In some embodiments, the step 620 of screen-printing a plurality of radiating elements may include screen-printing auxiliary elements. The auxiliary elements may be as described hereinabove in relation to phased array antenna 100 (schematically illustrated in FIG. 1A).

The method 600 may include a step 670 of coupling input ports. The step 670 may include, for each of the antenna modules, electrically coupling the radiating element to the signal input port. Thereby, the plurality of antenna modules may be assembled. In other words, the step 670 may include attaching non-printed electrical elements (e.g., probes) to the radiating elements.

In some embodiments, the step 670 may include a step 671 of punching holes in the fabric substrate and/or the radiating elements, to provide paths for the probes.

In some embodiments, the step 670 of electrically coupling the radiating element to the signal input port may include a step 673 of soldering the at least one probe to the radiating element, and/or a step 675 of gluing the at least one probe to the radiating element by a conductive adhesive.

In some embodiments, the at least one probe may include a conductive fiber (e.g., an e-thread). The step 670 may include a step 677 of stitching and/or sewing the conductive fiber to the fabric substrate.

In some embodiments, the at least one probe is aligned perpendicularly to a surface of said fabric substrate. In some embodiments, the radiating element may include a plurality of patches. For example, as described hereinabove in relation to FIGS. 3A-3C. In some embodiments, the at least one probe may include any one of a pin, a rivet, and/or a conductive via.

In some embodiments, some antenna modules may be configured for radiating in a first polarization, and some antenna modules may be configured for radiating in a second polarization. In some embodiments, the first polarization and the second polarization may be orthogonal polarizations. In some embodiments, some antenna modules may be dual polarization antenna modules (e.g., as described hereinabove in relation to FIG. 3C).

In some embodiments, the method 600 may include a step 640 of printing a ground plane. The ground plane may be printed on the fabric substrate, on a side opposing the radiating elements. In other words, the radiating elements may be printed on a first side of the fabric substrate. Further, the method 600 may include printing a ground plane on a second side of said fabric substrate. In some embodiments, the ground plane may be printed by a screen-printing process. It is noted that the order of steps 620 of screen-printing a plurality of radiating elements, and 640 of printing a ground plane, may be interchangeable.

In some embodiments, where a ground plane may be printed on the fabric substrate, the step 670 of electrically coupling the radiating element to the signal input port may include gluing the at least one probe to the radiating element by a conductive adhesive. Further, the method 600 may include gluing the at least one probe to the ground plane by a non-conductive adhesive (so as to prevent short-circuiting the radiating element to the ground plane).

In some embodiments, signal input port may include a coaxial radio frequency connector, as described hereinabove in relation to phased array antenna 100. The step 670 may include electrically coupling the inner conductor to the radiating element (e.g., galvanically, by soldering 673 or gluing 675). The step 670 may include galvanically coupling the outer conductor to the ground plane.

For example, in some embodiments, the coaxial radio frequency connector may be a SMA connector. The method 600 may include gluing a lead of the SMA connector to the radiating element by a conductive adhesive. The method 600 may further include gluing a flange of said SMA connector to said ground plane by a conductive adhesive.

In some embodiments, the method 600 may include steps for disposing at least one secondary layer. The at least one secondary layer may be as described hereinabove in relation to phased array antenna 220 (schematically illustrated in FIG. 2B). In some embodiments, the at least one secondary layer may be printed by a screen-printing process.

In some embodiments, the method 600 may include a step 620 of disposing an insulating layer on the radiating elements. The method 600 may further include a step 630 of disposing electrically conductive material on the insulating layer. Thereby, the at least one secondary layer may be formed. The at least one secondary layer obtained by step 630 may be described as disposed on a first side of the fabric substrate.

In some embodiments, where a ground plane may be printed on the fabric substrate, the method 600 may include a step 650 of disposing an insulating layer on the ground plane. The method 600 may further include a step 660 of disposing electrically conductive material on the insulating layer. Thereby, the at least one secondary layer may be formed. The at least one secondary layer obtained by step 660 may be described as disposed on a second side of the fabric substrate.

In some embodiments, a plurality of secondary layers may be disposed on any side of the fabric substrate. Insulating material and conductive material may iteratively be disposed. In other words, steps 620 630 and/or steps 650 660 may be repeated so as to dispose the plurality of secondary layers and insulating layers between any two adjacent secondary layers.

In embodiments where for both sides of the fabric substrate, a plurality of secondary layers may disposed, steps 620 630 may be performed before steps 650 660, or may be performed after steps 650 660. Further, steps 620 630 650 660 can be performed in zigzag fashion. That is, the specific order in which steps 620 630 650 660 are repeated is unimportant. It is noted, however, that between any two repetitions of step 630 a repetition of step 620 may be performed. Further, between any two repetitions of step 660 a repetition of step 650 may be performed.

In some embodiments, an inkjet printing process (also known as digital printing) may be used in conjunction to a screen-printing process or instead of the screen-printing process. In other words, an inkjet printing process may replace the screen-printing process, partially or completely.

In some embodiments, the method 600 may include a step 680 of disposing a protective cover. In other words, disposing a radome. In some embodiments, the step 680 may include fastening the protective cover to the phased array antenna (e.g., by screws, bolts, rivets, and/or clips), or gluing the protective cover to the phased array antenna. In some embodiments, the step 680 may include a step 685 of embedding the phased array antenna in a resin matrix. In some embodiments, the method may include bending the phased array antenna may before performing step 685 of embedding the phased array antenna in a resin matrix. The phased array antenna may be immersed in the resin, or the resin may be applied on (disposed on) the phased array antenna. The resin may be cured, and may be machined if necessary.

In some embodiments, the method 600 may include a step 690 of mechanically attaching the phased array antenna to a curved template surface. In other words, the phased array antenna may be mechanically attached to a curved surface of a platform. Attaching the fabric substrate to a curved template surface may include fastening the phased array antenna to the template surface (e.g., by screws, bolts, rivets, and/or clips), and/or gluing the phased array antenna to the template surface.

Having described and illustrated the principles of the disclosed technology with reference to the illustrated embodiments, it will be recognized that the illustrated embodiments can be modified in arrangement and detail without departing from such principles. The technologies from any example can be combined with the technologies described in any one or more of the other examples.

Therefore, casting into a language of clauses, the present disclosure provides phased array antennas, systems, and methods according to, but not limited to, the following clauses:

Clause 1: A phased array antenna comprising a plurality of antenna modules, each antenna module comprising:
a radiating element made of an electrically conductive material printed on a fabric substrate by any one of: a screen-printing process, and an inkjet printing process;
a signal input port comprising at least one probe electrically coupled to said radiating element, said probe being configured to be coupled to a corresponding transceiver module so that an amplitude and phase of each of said radiating elements can be independently controlled.

Clause 2: The phased array antenna according to clause 1, wherein said radiating element comprises a plurality of patches.

Clause 3: The phased array antenna according to any one of clauses 1 to 2, wherein said signal input port is electrically coupled to said radiating element by any one of a soldering, and a conductive adhesive.

Clause 4: The phased array antenna according to any one of the preceding clauses, wherein said at least one probe is aligned perpendicularly to a surface of said fabric substrate.

Clause 5: The phased array antenna according to clause 4, wherein said at least one probe comprises any one of a pin, a rivet, and a conductive via.

Clause 6: The phased array antenna according to any one of the preceding clauses, wherein said radiating elements are printed on a first side of said fabric substrate; and, comprising a ground plane disposed on a second side of said fabric substrate.

Clause 7: The phased array antenna according to clause 6, wherein said ground plane is printed on the fabric substrate by any one of: a screen-printing process, and an inkjet printing process.

Clause 8: The phased array antenna according to any one of clauses 6 to 7, wherein said at least one probe is electrically coupled to said at least one radiating element by a conductive adhesive, and mechanically attached to said ground plane by a non-conductive adhesive.

Clause 9: The phased array antenna according to any one of clauses 6 to 8, wherein said signal input port comprises a coaxial radio frequency connector.

Clause 10: The phased array antenna according to clause 9, wherein:
said coaxial radio frequency connector is a SMA connector;
a lead of said SMA connector is electrically coupled to a corresponding radiating element by a conductive adhesive; and
a flange of said SMA connector is electrically coupled to said ground plane by a conductive adhesive.

Clause 11: The phased array antenna system according to any one of the preceding clauses, wherein some antenna modules are configured for radiating in a first polarization, and some radiating antenna modules are configured for radiating in a second polarization.

Clause 12: The phased array antenna system according to clause 11, wherein said first polarization and said second polarization are orthogonal polarizations.

Clause 13: The phased array antenna system according to any one of clauses 11 to 12, comprising dual polarization antenna modules.

Clause 14: The phased array antenna according to any one of the preceding clauses, comprising at least one secondary layer.

Clause 15: The phased array antenna according to clause 14, comprising an insulating layer being disposed on said radiating elements, and wherein said at least one secondary layer is disposed on said insulating layer.

Clause 16: The phased array antenna according to any one of clauses 14 to 15, as dependent on clause 6, comprising an insulating layer being disposed on said ground plane, and said at least one secondary layer is disposed on said insulating layer.

Clause 17: The phased array antenna according to any one of clauses 14 to 16, wherein said at least one secondary layer is printed by any one of: a screen-printing process, and an inkjet printing process.

Clause 18: The phased array antenna according to any one of the preceding clauses, mechanically attached to a curved template surface.

Clause 19: The phased array antenna according to any one of the preceding clauses, comprising a protective cover.

Clause 20: The phased array antenna according to clause 19, wherein said protective cover comprises a resin matrix.

Clause 21: A phased array antenna system, comprising a plurality of transceiver modules and a phased array antenna according to any one of the preceding clauses, wherein each transceiver module is electrically coupled to said at least one probe so as to provide electromagnetic signals to said plurality of antenna modules.

Clause 22: The phased array antenna system according to clause 21, wherein said plurality of transceiver modules are configured for phase correcting said signals.

Clause 23: A method for manufacturing a phased array antenna comprising a plurality of antenna modules, wherein each antenna module comprises:
a radiating element; and
a signal input port comprising at least one probe configured to be coupled to a corresponding transceiver module, so that an amplitude and phase of each of said radiating elements can be independently controlled;
   the method comprising:
printing an electrically conductive material on a fabric substrate by any one of: a screen-printing process, and an inkjet printing process, so as to form said radiating element for each of the antenna modules; and
for each of the antenna modules, electrically coupling said radiating element to said signal input port, thereby assembling the plurality of antenna modules.

Clause 24: The method according to clause 23, wherein said radiating element comprises a plurality of patches.

Clause 25: The method according to any one of claims 23 to 24, wherein electrically coupling said radiating element to said signal input port comprises any one of soldering said at least one probe to said radiating element, and gluing said at least one probe to said radiating element by a conductive adhesive.

Clause 26: The method according to any one of claims 23 to 25, wherein said at least one probe is aligned perpendicularly to a surface of said fabric substrate.

Clause 27: The phased array antenna according to claim 26, wherein said at least one probe comprises any one of a pin, a rivet, and a conductive via.

Clause 28: The method according to any one of clauses 23 to 27, wherein said radiating elements are printed on a first side of said fabric substrate; and, the method comprises printing a ground plane on a second side of said fabric substrate.

Clause 29: The method according to clause 28, wherein said ground plane is printed by any one of: a screen-printing process, and an inkjet printing process.

Clause 30: The method according to any one of clauses 28 to 29, wherein electrically coupling said radiating element to said signal input port comprises gluing said at least one probe to said radiating element by a conductive adhesive; and, the method comprises gluing said at least one probe to said ground plane by a non-conductive adhesive.

Clause 31: The method according to any one of clauses 28 to 30, wherein said signal input port comprises a coaxial radiofrequency connector.

Clause 32: The method according to clause 31, wherein said coaxial radiofrequency connector is a SMA connector, the method comprises gluing a lead of said SMA connector to said radiating element by a conductive adhesive, and gluing a flange of said SMA connector to said ground plane by a conductive adhesive.

Clause 33: The method according to any one of clauses 23 to 32, wherein some antenna modules are configured for radiating in a first polarization, and some antenna modules are configured for radiating in a second polarization.

Clause 34: The method according to clause 32, wherein said first polarization and said second polarization are orthogonal polarizations.

Clause 35: The method according to any one of clauses 33 to 34, wherein some antenna modules are dual polarization antenna modules.

Clause 36: The method according to any one of clauses 23 to 35, comprising disposing an insulating layer on said radiating elements; and, disposing electrically conductive material on said insulating layer, thereby forming at least one secondary layer.

Clause 37: The method according to any one of clauses 23 to 36, as dependent on clause 28, comprising disposing an insulating layer on said ground plane; and, disposing electrically conductive material on said insulating layer, thereby forming at least one secondary layer.

Clause 38: The method according to any one of clauses 36 to 37, wherein said at least one secondary layer is printed by any one of: a screen-printing process, and an inkjet printing process.

Clause 39: The method according to any one of clauses 23 to 38, comprising mechanically attaching said phased array antenna to a curved template surface.

Clause 40: The method according to any one of clauses 23 to 39, comprising disposing a protective cover.

Clause 41: The method according to clause 40, comprising embedding in a resin matrix.

1. A phased array antenna comprising a plurality of antenna modules, each antenna module comprising:
a radiating element made of an electrically conductive material printed on a fabric substrate by any one of: a screen-printing process, and an inkjet printing process;
a signal input port comprising at least one probe electrically coupled to said radiating element, said probe being configured to be coupled to a corresponding transceiver module so that an amplitude and phase of each of said radiating elements can be independently controlled.

2. The phased array antenna according to claim 1, wherein said at least one probe is aligned perpendicularly to a surface of said fabric substrate, and wherein said at least one probe comprises any one of a pin, a rivet, and a conductive via.

3. The phased array antenna according to claim 1, wherein:
said radiating elements are printed on a first side of said fabric substrate;
comprising a ground plane disposed on a second side of said fabric substrate;
said ground plane is printed on the fabric substrate by any one of: a screen-printing process, and an inkjet printing process; and
said signal input port comprises a coaxial radio frequency connector.

4. The phased array antenna according to claim 1, wherein some antenna modules are configured for radiating in a first polarization, and some radiating antenna modules are configured for radiating in a second polarization, and wherein the phased array antenna comprises dual polarization antenna modules.

5. The phased array antenna according to claim 1, comprising at least one secondary layer.

6. The phased array antenna according to claim 5, comprising an insulating layer being disposed on said radiating elements, and wherein said at least one secondary layer is disposed on said insulating layer.

7. The phased array antenna according to claim 5, comprising:
a ground plane disposed on a second side of said fabric substrate; and
an insulating layer being disposed on said ground plane, and said at least one secondary layer is disposed on said insulating layer.

8. The phased array antenna according to claim 5, wherein said at least one secondary layer is printed by any one of: a screen-printing process, and an inkjet printing process.

9. The phased array antenna according to claim 1, mechanically attached to a curved template surface.

10. A phased array antenna system, comprising a plurality of transceiver modules and a phased array antenna according to claim 1, wherein each transceiver module is electrically coupled to said at least one probe so as to provide electromagnetic signals to said plurality of antenna modules.

11. The phased array antenna system according to claim 10, wherein said plurality of transceiver modules are configured for phase correcting said signals.

12. A method for manufacturing a phased array antenna comprising a plurality of antenna modules, wherein each antenna module comprises:
a radiating element; and
a signal input port comprising at least one probe configured to be coupled to a corresponding transceiver module, so that an amplitude and phase of each of said radiating elements can be independently controlled;
the method comprising:
printing an electrically conductive material on a fabric substrate by any one of: a screen-printing process, and an inkjet printing process, so as to form said radiating element for each of the antenna modules; and
for each of the antenna modules, electrically coupling said radiating element to said signal input port, thereby assembling the plurality of antenna modules.

13. The method according to claim 12, wherein said at least one probe is aligned perpendicularly to a surface of said fabric substrate, and wherein said at least one probe comprises any one of a pin, a rivet, and a conductive via.

14. The method according to claim 12, wherein:
said radiating elements are printed on a first side of said fabric substrate;
the method comprises printing a ground plane on a second side of said fabric substrate;
said ground plane is printed by any one of: a screen-printing process, and an inkjet printing process; and
wherein said signal input port comprises a coaxial radiofrequency connector.

15. The method according to claim 12, wherein some antenna modules are configured for radiating in a first polarization, and some antenna modules are configured for radiating in a second polarization, wherein some antenna modules are dual polarization antenna modules.

16. The method according to claim 12, comprising disposing an insulating layer on said radiating elements; and, disposing electrically conductive material on said insulating layer, thereby forming at least one secondary layer.

17. The method according to claim 12, comprising:
printing a ground plane on a second side of said fabric substrate;
disposing an insulating layer on said ground plane; and,
disposing electrically conductive material on said insulating layer, thereby forming at least one secondary layer.

18. The method according to claim 17, wherein said at least one secondary layer is printed by any one of: a screen-printing process, and an inkjet printing process.

19. The method according to claim 12, comprising mechanically attaching said phased array antenna to a curved template surface.
